(19) United States
(12) Patent Application Publication
(10) Pub. No.: US 2003/0204441 A1
(43) Pub. Date: Oct. 30, 2003

(54) Customized messaging on point-of sale systems

(76) Inventors: Charles V. Ellis, Newton, MA (US); John Hanzl, Boston, MA (US); Marc Mercuri, Brighton, MA (US)

Correspondence Address: FISH & RICHARDSON PC, 225 FRANKLIN ST, BOSTON, MA, 02110, US

(21) Appl. No.: 10/132,842

(22) Filed: Apr. 25, 2002

(51) Int. Cl. G06F 17/60

(52) U.S. Cl. 705/14; 705/26

(57) ABSTRACT

A method for providing, to a customer at a point of sale, information for obtaining an award includes receiving, from a point-of-sale (“POS”) system, transaction data representative of a transaction engaged in by the customer and, on the basis of the transaction data, identifying at least one eligible award. The transaction data and the award data is incorporated into an award code and communicated to the customer by the point-of-sale system. The customer can then redeem the award by providing the award code to a redemption server.

### FIELD OF INVENTION

This invention relates to point-of-sale (“POS”) systems, and in particular, to external interfaces to a POS system.

### BACKGROUND

Retail and restaurant outlets are the largest channels of trade in the economy, attracting virtually every customer many times every week. Information concerning the many transactions carried out at these locations is made available by POS (point-of-sale) systems at those locations. Such data is of particular interest in market research.

One limitation of transaction data collected by POS systems is that it is difficult to associate that data with individual customers. If a customer pays by credit card, it is possible to obtain some rudimentary demographic information concerning the customer. However, additional data concerning a customer is generally unavailable without securing the customer's cooperation.

Traditional methods of obtaining additional data concerning the customer include market surveys, interviews, and the like. However, data gathered in this manner is not associated with any particular transaction or transaction history at a POS. This lack of association limits the usefulness of data gathered in this way.

### SUMMARY

The invention provides a mechanism for collecting data concerning a customer in a manner that maintains the association of that data with transactions in which the customer has engaged. This includes communicating, using a communication network, e.g., a computer network or a telephone network, data concerning an interaction between customers and retail stores or restaurants, hereafter collectively referred to as “vendors,” and optionally to the manufacturers that supply those vendors.

The invention also relates to machine-readable media containing instructions which, when accessed, cause a machine to interface with a vendor's point-of-sale (“POS”) systems, to dynamically evaluate certain properties associated with the customer's interaction with the vendor, and to modify the printed output of the POS system. This printed output is known by many names, such as the “guest check,” the “bill,” the “receipt,” and the like. The essential property of the printed output is that it is likely to be carried away by the customer and can therefore be referred to at a later time.

In one practice, the invention provides a method for providing, to a customer at the point of sale, information for obtaining an award. The method includes receiving, from a point-of-sale system, transaction data representative of a transaction engaged in by the customer. On the basis of the transaction data, at least one eligible award is identified. The transaction data and at least one eligible award are then encoded into an award code, which is ultimately communicated to the customer by a POS system or by a system in data communication with the POS system.

Another practice of the invention provides an award to a customer, by receiving, from the customer, an award code identifying the award and including transaction data associated with a transaction, and additional customer-specific data. The award code is then decoded and the customer-specific data is associated with the transaction data. Data representative of an award listed on the award code is then communicated to the customer.

Unless otherwise defined, all technical and scientific terms used herein have the same meaning as commonly understood by one of ordinary skill in the art to which this invention belongs. Although methods similar or equivalent to those described herein can be used in the practice or testing of the present invention, suitable methods are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following claims, the detailed description, and the accompanying figures.

### BRIEF DESCRIPTION OF THE FIGURES

FIG. 1 is an overview of the process carried out by a system incorporating the invention.

FIG. 2 is a system associated with the vendor site.

FIG. 3 is a portion of the guest check from FIG. 1.

FIG. 4 is an illustration of the constituent portions of the award code on FIG. 2.

FIG. 5 is a system for receiving award codes from a customer.

### DETAILED DESCRIPTION

Overview

A system incorporating the invention modifies output of a POS system by encoding a variety of properties associated with the customer's visit into a unique alphanumeric award code and communicating that award code to a customer. The award code can be printed prominently on a guest check or otherwise transmitted and made available to the customer, for example by transmitting it to a customer's own portable processing system. Additional text displayed in association with the printed output invites the customer to retrieve one or more awards, by, for example, visiting a URL or calling a designated telephone number, one or both of which are also displayed on the printed output. In certain embodiments, the URL is that of a vendor's web site. However, URLs pointing to other web sites can also be included on the printed output. In addition, the printed output can list more than one URL. A customer who initiates contact, either by visiting the web site or by telephoning the designated telephone number is then prompted to enter the award code imprinted on their printed output.

Properties represented by the award code can include, but are not limited to, the particular retail or restaurant establishment the customer visited; the date and hour of the visit; a unique identifier for the particular printed output; the number of prior interactions the customer has had with the vendor; the amount spent; the particular specific ingredients used in any products purchased from that vendor; the general product categories of products purchased from that vendor; the server(s), cashier(s), or salesperson(s) that provided various services to the customer during the transaction; the revenue center at which the transaction took place (e.g., take-out window, or bar, or men's shoes section, etc.); the number of additional guests who accompanied the customer, etc. The award code also provides a unique link between information provided by the customer about themselves and a detailed transaction database reflecting all properties of the customer's visits to the vendor such as may be built from point-of-sale transaction data.

Customers who choose to redeem their award do so by initiating contact with a redemption server. A variety of communication methods are available for initiating such contact. These include accessing a vendor's web site, calling a designated IVR (Interactive Voice Response) number, using a set-top box, a kiosk, or other communication mechanism.

Upon contacting the redemption server, the customer is asked to submit some basic identity and/or address information, as well as the specific award code. The customer does so by completing a web form, by entering it into a telephone keypad, by saying it to a device executing a speech-recognition process, or by using any other available data input mechanism. The customer's submission of the award code causes additional computer software to decrypt the award code into its constituent pieces of information, and to apply rules that determine what types of awards or other responses to provide to the customer. These awards or other responses are delivered to the customer via either electronic or conventional mail.

Awards can be printable coupons, gift certificates, credit-card or other rebates, offers to retrieve free merchandise, contest entries, interactive “scratch cards” or “lotto cards,” so-called calls-to-action, etc. These awards may in many cases be redeemed upon a return visit to the issuing vendor or to another vendor. For example, an award issued by a restaurant can be redeemed in another channel of trade entirely, such as a grocery store.

Various entities may each want to issue awards to retail or restaurant customers. Such entities include retail or restaurant companies seeking to develop and maintain direct relationships with their customers; manufacturers who supply the foregoing entities and who likewise seek to develop and maintain direct relationships with customers who directly or indirectly use or consume their products or other products of the same type; and various national entities, for example chain restaurants or retail stores, offering broad-based programs, products and services of interest to the dining and purchasing public who are also interested in developing and maintaining relationships with their customers. These and other entities can interact with retail or restaurant customers directly, and can additionally partner with one another to provide enhanced or combinatorial awards.

The award code incorporates transaction data that identifies the transaction represented by the printed output from among a multiplicity of transactions carried out daily by various POS systems. A system that collects such transaction data can significantly enhance a vendor's long-term ability to sustain relationships directly with customers and to encourage customers to consume more of the same product or to try different products. Modem computerized POS systems, commonly used by vendors such as retail shops or restaurants, can capture many details of any customer's interaction with that vendor. These details include:

tendering information, such as how the check was paid, which credit cards were used, whether any house charges were imposed, or whether discounts or coupons were used;

product information, such as the SKU number of a purchased item, what meals were ordered and how they were served or prepared;

retail or restaurant-specific information, such as who served the party or sold the goods, which part of the retail or restaurant the meal or transaction occurred in, which table(s) were used; and

date/time information, such as when the party was first seated, the exact times at which each item was ordered, when the party left.

A customer who later redeems the award code provides additional customer-specific information, including, but not limited to email address, home address, and personal preferences. This customer-specific information is associated with the transaction data that is already encoded by the award code. The association between customer-specific information and transaction data provides the vendor with an array of segmentation tools for precisely targeting messages to customers by any meaningful criterion.

A customer benefits from redeeming the award code by receiving additional product and price benefits, possibly from many different entities, for example, from the retailer or restaurateur, multiple suppliers/manufacturers; and multiple national entities as described above. Benefits can extend across many different buying channels. Since benefits are only awarded when the customer initiates contact, all programs are inherently opt-in. Participation is solely at the customer's convenience and discretion.

A vendor who prints award code benefits by establishing a non-invasive way to associate transaction data with customer-specific data. The vendor obtains this benefit without the need to change operating procedures within the retail or restaurant establishment, and without having to make significant changes to the existing POS system. A system incorporating the invention maximizes manufacturer/supplier participation and customer involvement, enables virtually infinite segmentation of customer messaging, and permits rapid and automatic response to a customer. This results in a cost-effective messaging tool.

In a retail environment, the award code enables retailers to track an SKU all the way to the customers' home or place of business. In a restaurant environment, items that are manufactured on the premises, and which therefore are not identified by SKU's, can likewise be tracked. A system incorporating the invention allows dynamic interpretation of items ordered to determine their underlying product ingredients and, therefore, the manufacturers of those ingredients. This provides manufacturers with one-to-one interaction with both “direct” and “indirect” customers of their products, as well as underlying data that may be useful in determining how to increase consumption of those products. Manufacturers can “follow” customers across trade channels. Manufacturers can more effectively partner with retailers or restaurants to deliver value to customers and retail or restaurants alike.

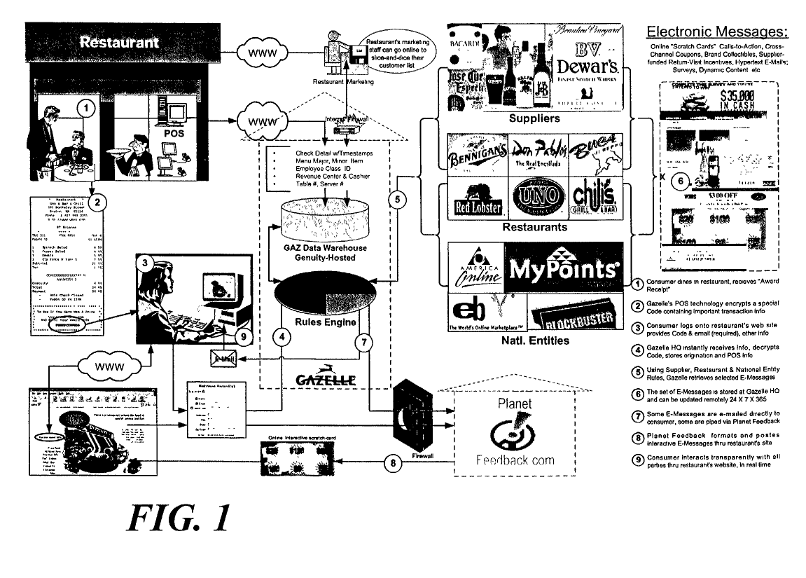

FIG. 1 shows the entire process from the viewpoint of a restaurant customer. After dining at a restaurant, a customer receives a guest check (step 1). The system of the invention uses the existing POS system to generate an award code containing selected information associated with the customer's restaurant visit and to print that award code either on the guest check itself or on an accompanying “dupe” (step 2). The system also prints an accompanying invitation to call a particular telephone number or to visit a web site to redeem that code.

In response to the invitation, the customer later logs onto a web site identified on the printout or calls an interactive voice response (“IVR”) telephone number, also identified on the print-out (step 3). In response to prompting at that web site or by telephone, the customer provides the code, together with additional customer-specific information.

Both the customer-specific information and the code are transmitted in real time to a redemption server. The redemption server decrypts the code (step 4), and stores the data contained therein in association with the customer-specific information. Using rules supplied by either the supplier, the retailer or restaurant, and/or a national entity (such as a chain restaurant or retailer), the redemption server retrieves messages associated with the rewards encoded in the award code (step 5). These messages are stored at the redemption server and can be remotely updated by any of the foregoing entities at any time (step 6). The redemption server then causes the messages to be routed to the appropriate parties using the appropriate communication channels (steps 7,8). Certain messages are sent directly to the customer, either by electronic or conventional mail, by fax, or by electronic messaging protocols such as http, WAP, SMS, etc. Other messages are piped via other online or direct marketing partners. The customer thus interacts transparently, and in real-time, with all necessary parties (step 9).

The Vendor Side

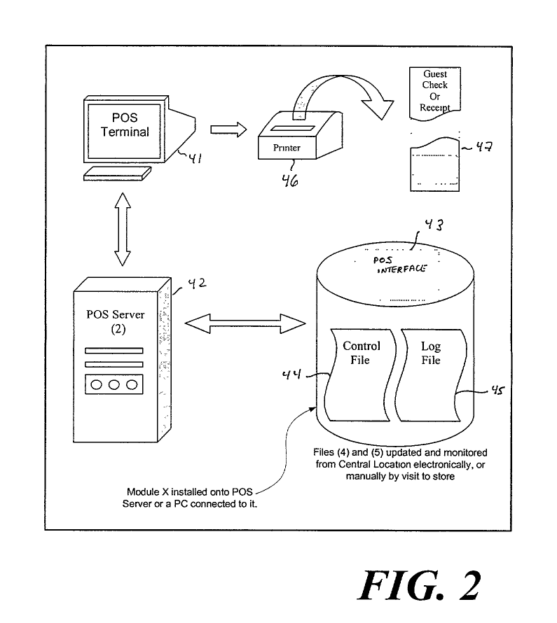

FIG. 2 shows the portion of the system that resides at the restaurant or retail store. This portion, referred to herein as the “vendor-side” portion, interacts with an existing POS server 42 to cause a printer 46 to print a dynamically selected message on a guest check 7 or on a separate piece of paper.

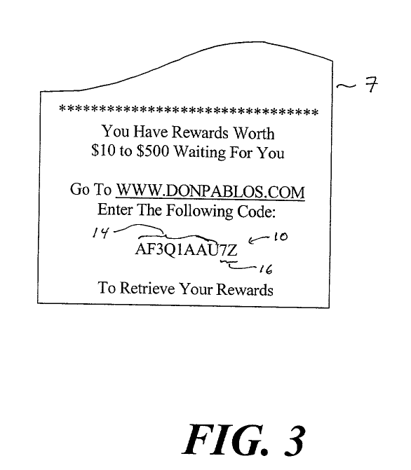

The system includes a POS interface 43 whose function is to interface with the existing POS server 42 to cause the printer 46 to print certain items on the customer's receipt or guest check 7 during, or at the conclusion of a retail purchase or restaurant meal. FIG. 3 shows a representative guest check 7 on which are imprinted a dynamically generated award code 10 containing information representative of the transaction; and redemption instructions 12. The award code 10 is generated when the transaction meets one or more pre-determined conditions established by an awarding entity. Such conditions can include the purchase of a particular item or the purchase of any item from a particular category of items. However, the condition need not depend on what was purchased. For example, a condition may provide an award to the tenth customer after a specified time. Any and all of these conditions can be mixed and matched, as well as changed over time.

For example, when a customer orders a meal at a restaurant, a waiter opens a check by interacting with a POS terminal 41. At the end of the meal, in response to an instruction to communicate the guest check 47 to the customer, the POS server 42 notifies the POS interface 43 that it is now ready to print the check. The POS interface 43 then reads a control file 44 containing a list of award conditions. Award conditions can be set based on many criteria, including current promotions, which servers or salespeople were involved, what type of credit card or other payment method was used, or how many times a particular set of credit card numbers has been seen before. The POS interface 43 then queries the POS server 42 for selected data associated with the transaction, hereafter referred to as “transaction data.”

If the POS interface 43 determines that the transaction data fulfills the award conditions for one or more awards, an award code 10 identifying those awards is inserted into a message to be communicated to the customer by the POS system.

The POS interface 43 then provides this message, including the award code 10, to the POS server 42. The POS server 42 then causes this message to be communicated to the customer. Communication of the message can take place by printing it on a guest check 47 to be given to the customer or by communicating the message to a portable processing device carried by the customer. In the latter case, the message can include data representative of text or data that can be transformed into a spoken utterance by the portable processing device.

Finally, the POS interface 43 writes the award code 10, together with the transaction data, into a log file 45.

Both the control file 44 and the log file 45 are inspected and maintained by a separate and independent off-line process. Maintenance can be carried out either by a continuous network connection to a maintenance facility, or by periodically establishing communication with a maintenance facility, for example by telephone or by a network connection. Additionally, a support engineer can visit the site and load new rules from a removable machine-readable medium.

As shown in FIG. 2, the control file 5 and a log file 4 are not part of the POS system and communication with the POS system is carried out by a POS interface 43. However, the POS system itself can be modified to carry out the method described herein.

The Award Code

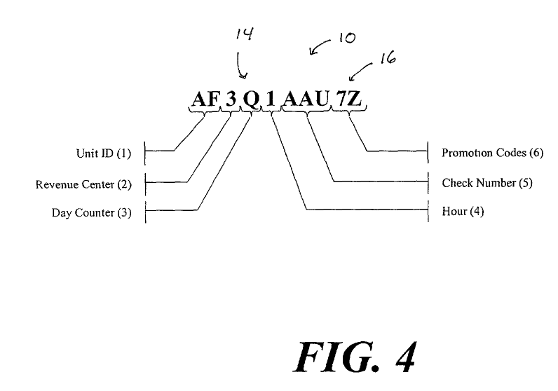

Referring to FIG. 4, an award code 10 includes an identifying portion 14 and an award portion 16. The identifying portion 14 contains transaction data, such as information identifying the restaurant or retail store that engaged in the transaction; the date and time of the transaction; the POS system guest check 47 or receipt transaction ID; and similar information about the transaction itself. The award portion 16 includes information identifying a variable number of awards that the POS interface 43 identified as having been triggered by the transaction data. If the POS interface 43 determines that the transaction data does not trigger any award, then no award code 10 is printed on the guest check 47.

The identifying portion 14 of the representative award code 10 includes a unit ID uniquely identifying the restaurant or store. In the representative award code 10, the unit ID is a two character code based on a fixed offset. The offset is set within code and is used to reduce the number of characters required to encode the Unit ID. The award code 10 further includes a revenue center ID to identify the particular revenue center within the restaurant or store at which the transaction was consummated. For a retailer, examples of revenue centers might include men's clothing, outdoor goods, and the like. For restaurants, examples of revenue centers include take-out, bar, or outdoor seating.

In addition to data identifying where the transaction took place, the identifying portion 14 also includes data indicating when the transaction took place. This data includes a day counter, which in this representative embodiment is a one character code that is incremented daily. With 32 available alphanumeric characters, the day counter repeats itself once every 32 days. The identifying portion 14 also includes an hour counter, which in this representative embodiment is a one character code that is incremented hourly. To further identify the transaction, the identifying portion 14 also includes a check number. In this representative embodiment, the check number has three characters. With 32 alphanumeric characters to choose from, the check number can range between 0 and 32767. For large retailers, a fourth character can be provided for the check number.

The identifying portion 14 described herein is deemed sufficiently detailed to identify a particular transaction from among all the transactions in a multiplicity of POS systems. Should this not be the case, the identifying portion 14 can be readily modified to include sufficient detail to distinguish a particular transaction from all other transactions.

The award portion 16 of the award code 10 consists of a variable number of characters, the exact number being dependent on a setting within the control file 44. Each character identifies an award for which the transaction is eligible.

The transaction data collected by various POS systems can then be linked to customer-specific data provided later by the customer. The customer provides this data by responding to the invitation to provide the award code 10 to a redemption server. The customer can do so using a variety of communication networks, such as the internet, a telephone, a kiosk or a TV set-top system.

Each constituent component of the award code 10 is represented in the control file 44 by a number in a particular base, typically base 10. To create the award code 10, the appropriate constituents from the award code 10 are retrieved from the control file 44 and converted into another, higher base. This conversion from a lower base to a higher base enables a number to be represented by fewer digits with more symbols per digit, thereby reducing the space that that number occupies on the printed award code 10. In the illustrated embodiment, the base 10 numbers are converted into base 32 numbers, thereby making many of the alphanumeric characters available for representing that number on the printed POS output.

The Unit ID that identifies a particular store or restaurant is always encrypted using a standard base, such as base 32, with the symbols representing digits in that base in a standard order. This enables the Unit ID to always be decoded. Once decoded, the Unit ID can be used to identify the encryption keys for all the remaining constituents of the award code 10.

The remaining constituents of the award code 10 can be encoded by converting them to a different base. This base need not be the same as the base used to encrypt the unit ID. Nor does each constituent of the award code 10 have to be converted to the same base. As noted above, the Unit ID can identify encryption keys for each constituent of the award code 10 separately from all other constituents. This feature enables the encryption key for a particular constituent of the award code 10, which is stored in the control file 44 associated with a particular vendor, to be easily changed on a vendor-by-vendor level.

The encryption key for a particular constituent of the award code 10 can be changed by converting a number representing an award constituent to a different base before printing that number on the printed output. This provides control over the number of digits needed to represent that constituent on the printed award code 10. In addition, the encryption key can be changed by changing the mapping from symbol to number in a particular base. For example, by convention the symbol “A” means “10” in base 16. An alternative mapping might cause the symbol “1” to represent “10” and instead make the symbol “A” mean “3.” By changing the base and scrambling the symbol-to-number mapping frequently and at random intervals, the possibility of forgery is significantly reduced.

In some embodiments, the symbol-to-number mapping includes only upper-case letters, thereby reducing the likelihood of error when typing the award code 10 into a web browser, or the tedium of having to verbally distinguish between upper and lower-case letters when reading the award code 10 into a telephone. In other embodiments, the symbol-to-number mapping excludes easily confused symbols, such as “O” and “0,” and “1” and “I” to further reduce the possibility of error.

The Redemption Side

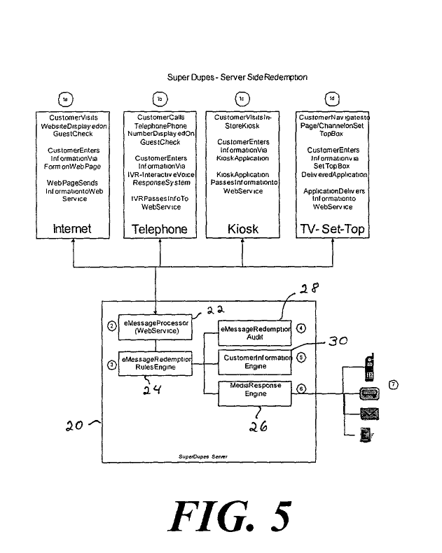

FIG. 5 shows a portion of the system with which the customer interacts to redeem the award code 10. This portion includes a redemption server 20 executing a web service 22. The web service 22 functions as a universal interface for communicating with a customer either through the internet, by telephone using an interactive voice response system, through a kiosk, through a television set-top unit, or any other communication medium. Using any of the foregoing communication media, the web service 22 prompts the customer to enter or otherwise provide the award code 10 and customer-specific information.

The web service 22 then passes the award code 10 to a redemption engine 24, executing on the redemption server 20 or on another system connected thereto. The redemption engine 24 decrypts the award code 10 and identifies, at least in part on the basis of transaction data from the award code 10, the awards that the customer is entitled to. The redemption engine 24 then determines an appropriate response to the customer.

Appropriate responses can include electronic messages containing coupons, calls to action, information messages, and other content. These messages can be delivered to the customer using the communication medium that the customer used to contact the redemption server 20. Alternatively, the redemption engine 24 can cause a media-response engine 26 to generate the response using a communication medium other than that used by the customer to communicate with the redemption server 20. This may be necessary if, for example, the appropriate response includes a coupon and the customer contacted the redemption server 20 by telephone. In such a case, the coupon would be mailed to the customer.

Other embodiments provide an auditing engine 28 in communication with the redemption engine 24. In these embodiments, the auditing engine receives, from the redemption engine 24, information representative of promotions redeemed. The data accumulated by the auditing engine 28 can then be accessed by market researchers to evaluate the effectiveness of promotions.

Still other embodiments provide a customer-information engine 30 in communication with the redemption engine 24. The customer-information engine 30 accumulates customer-specific information provided by customers and associates that information with the transaction data provided by the award code 10. This association between customer-specific information and transaction data is also of particular interest to market researches.

### Implementations

The invention can be implemented in hardware or software, or a combination of both. The invention can be implemented in computer programs using standard programming techniques following the method steps and figures described herein. The programs should be designed to execute on programmable computers each comprising a processor, a data storage system (including memory and/or storage elements), at least one input device, and at least one output device, such as a CRT or printer. Program code is applied to input data to perform the functions described herein and generate output information. The output information is applied to one or more output devices such as a CRT, as described herein.

Each program is preferably implemented in a high level procedural or object oriented programming language to communicate with a computer system. However, the programs can be implemented in assembly or machine language, if desired. In any case, the language can be a compiled or interpreted language.

Each such computer program is preferably stored on a storage medium or device (e.g., ROM or magnetic diskette) readable by a general or special purpose programmable computer, for configuring and operating the computer when the storage media or device is read by the computer to perform the procedures described herein. The system can also be considered to be implemented as a computer-readable storage medium, configured with a computer program, where the storage medium so configured causes a computer to operate in a specific and predefined manner to perform the functions described herein.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

We claim:

1. A method for providing, to a customer at a point of sale, information for obtaining an award, the method comprising:
receiving transaction data representative of a transaction engaged in by the customer;
on the basis of the transaction data, identifying at least one eligible award;
encoding the transaction data and data identifying the at least one eligible award into an award code; and
causing a point-of-sale system to communicate the award code to the customer.

2. The method of claim 1, wherein causing the point-of-sale system to communicate the award code comprises causing the point-of-sale system to prepare printed output having the award code imprinted thereon.

3. The method of claim 2, wherein causing the point-of-sale system to communicate the award code comprises causing the point-of-sale system to imprint an alphanumeric award code on said printed output.

4. The method of claim 1, wherein causing the point-of-sale system to communicate the award code comprises causing the point-of-sale system to transmit the award code to a customer processing system.

5. The method of claim 1, wherein causing the point-of-sale system to communicate the award code comprises causing the point-of-sale system to communicate data representative of an utterance.

6. The method of claim 1, wherein encoding the transaction data and the at least one eligible award comprises:
retrieving a number representative of a constituent of the award code, the number being represented in a first number base,
translating the number into a second number base different from the first number base, and
incorporating the translated number into the award code.

7. The method of claim 1, wherein receiving transaction data comprises receiving the transaction data from a point-of-sale system.

8. The method of claim 1, wherein receiving transaction data comprises receiving the transaction data from a component of a point-of-sale system.

9. A method for providing an award to a customer, the method comprising:
receiving, from the customer, an award code identifying the award;
receiving, from the customer, additional customer-specific data;
decoding the award code; and
communicating data representative of the award to the customer.

10. The method of claim 9, further comprising associating the customer-specific data with transaction data incorporated into the award code.

11. The method of claim 9, wherein receiving an award code comprises providing a web service to communicate with a customer through a communication network.

12. The method of claim 9, wherein receiving an award code comprises receiving information from a customer through an electronic communication network.

13. The method of claim 12, wherein receiving information through an electronic communication network comprises receiving information from an electronic communication network selected from the group consisting of a computer network, a telephone network, a cable network, and a wireless network.

14. A computer-readable medium having encoded thereon software for providing, to a customer at a point of sale, information for obtaining an award, the software comprising instructions for:
receiving transaction data representative of a transaction engaged in by the customer;
on the basis of the transaction data, identifying at least one eligible award;
encoding the transaction data and data identifying the at least one eligible award into an award code; and
causing a point-of-sale system to communicate the award code to the customer.

15. The computer-readable medium of claim 14, wherein the instructions for causing the point-of-sale system to communicate the award code comprise instructions for causing the point-of-sale system to prepare printed output having the award code imprinted thereon.

16. The computer-readable medium of claim 15, wherein the instructions for causing the point-of-sale system to communicate the award code comprise instructions for causing the point-of-sale system to imprint an alphanumeric award code on said printed output.

17. The method of claim 14, wherein the instructions for causing the point-of-sale system to communicate the award code comprise instructions for causing the point-of-sale system to transmit the award code to a customer processing system.

18. The method of claim 14, wherein the instructions for causing the point-of-sale system to communicate the award code comprise instructions for causing the point-of-sale system to communicate data representative of an utterance.

19. The computer-readable medium of claim 14, wherein the instructions for encoding the transaction data and the at least one eligible award comprise instructions for:
retrieving a number representative of a constituent of the award code, the number being represented in a first number base,
translating the number into a second number base different from the first number base, and
incorporating the translated number into the award code.

20. The method of claim 12, wherein the instructions for receiving transaction data comprise instructions for receiving the transaction data from a point-of-sale system.

21. The method of claim 12, wherein the instructions for receiving transaction data comprise instructions for receiving the transaction data from a component of a point-of-sale system.

22. A computer-readable medium for providing an award to a customer, the computer-readable medium having encoded thereon instructions for:
receiving, from the customer, an award code identifying the award;
receiving, from the customer, additional customer-specific data;
decoding the award code; and
communicating data representative of the award to the customer.

23. The computer-readable medium of claim 22, wherein the software further comprises instructions for associating the customer-specific data with transaction data incorporated into the award code.

24. The computer-readable medium of claim 22, wherein the instructions for receiving an award code comprise instructions for providing a web service to communicate with a customer through a communication medium.

25. The computer-readable medium of claim 22, wherein the instructions for receiving an award code comprise instructions for receiving information from a customer through an electronic communication medium.

26. The computer-readable medium of claim 25, wherein the instructions for receiving information through an electronic communication medium comprise instructions for receiving information from an electronic communication medium selected from the group consisting of a computer network, a telephone network, a cable network, and a wireless network.
